(19) United States
(12) Patent Application Publication
(10) Pub. No.: US 2006/0105745 A1
(43) Pub. Date: May 18, 2006

(54) System and method for protecting data provided by a cellular telephone

(76) Inventor: Edward H. Frank, Atherton, CA (US)

Correspondence Address: CHRISTIE, PARKER & HALE, LLP, PO BOX 7068, PASADENA, CA, 91109-7068, US

(21) Appl. No.: 11/239,870

(22) Filed: Sep. 29, 2005

Related U.S. Application Data
(60) Provisional application No. 60/621,580, filed on Oct. 22, 2004.

(51) Int. Cl. H04M 1/66

(52) U.S. Cl. 455/411; 455/410

(57) ABSTRACT

A method for authenticating a user to a cellular telephone includes providing a cellular telephone, providing a matrix having a plurality of authentication parameters in one dimension and a plurality of applications provided by the cellular telephone in another dimension, associating each of the plurality of applications provided by the cellular telephone with one or more of the plurality of authentication parameters of the matrix and satisfying one or more authentication parameters to provide access to one or more applications to a user of the cellular telephone.

### CROSS-REFERENCE TO RELATED APPLICATION(S)

This application claims priority to and the benefit of U.S. Provisional Application No. 60/621,580, filed Oct. 22, 2004, the entire content of which is incorporated herein by reference.

### FIELD OF THE INVENTION

The present invention relates to a system and method for the authentication of a user of a cellular telephone.

### BACKGROUND

Cellular communication systems are multi-user, wireless communication systems capable of concurrent use by large numbers of users. These systems may be packet wireless communication systems providing voice and other real-time communications to mobile devices operable in such a system. Advancements in communication technologies have permitted the development and popularization of new types of mobile devices for use with cellular communication systems. Multi-function mobile communication systems are exemplary of systems made possible as result of such advancements.

In order to ensure the validity of a user of such a device, authentication parameters are carried out to ensure that access to the device is granted only to an authorized user. Recently however, with the advancing sophistication of mobile devices in general, there is an ever-increasing array of services available which may be provided on mobile devices. Cell-phones in particular have developed to the point that e-mail, messaging, camera and other services may all be provided by the cell-phone in addition to voice telephony services.

However, authentication parameters used to protect these services have not similarly advanced to match the sophistication of today's cellular telephones. Current cellular telephones are still authenticated for the most part by a single authentication parameter such as the entry of a pass code used to “unlock” the device, providing an “all or nothing” approach for cellular telephone authentication.

Given that the data and services provided by the cellular telephone vary in importance to a user, and given that authentication parameters will ordinarily be more or less cumbersome based on the level of security they provide, what is needed is a system of authentication offering a tradeoff between these two ideals by tailoring authentication parameters to individual services offered on a cellular telephone.

### SUMMARY OF THE INVENTION

A method for authenticating a user to a cellular telephone includes providing a cellular telephone; providing a matrix having a plurality of authentication parameters in one dimension and a plurality of applications provided by the cellular telephone in another dimension; associating each of the plurality of applications provided by the cellular telephone with one or more of the plurality of authentication parameters of the matrix; and satisfying one or more of the associated authentication parameters to provide access to one or more of the associated applications to a user of the cellular telephone.

A system includes a cellular telephone for running a plurality of applications and an agent for providing first and second authentication parameters for authenticating a user of the cellular telephone to first and second applications running on the cellular telephone. The first application is enabled by authenticating a user through the first authentication parameter, and the second application is enabled by authenticating the user through the second authentication parameter. The agent authenticates the user to the first application following the first authentication parameter, and the agent authenticates the user to the second application following the second authentication parameter.

In another embodiment, a method for authenticating a user to a cellular telephone to includes providing one or more applications and assigning a plurality of authentication parameters to the one or more applications to authenticate a user of the cellular telephone to the one or more applications. Each authentication parameter has a criterion for satisfaction, and the criterion for satisfaction of a first authentication parameter changes in response to satisfaction of the criterion of a second authentication parameter.

### BRIEF DESCRIPTION OF THE DRAWINGS

FIG. 1 shows a typical wireless network;

FIG. 2 shows a simple network in which two sub-networks are coupled by a router which selectively passes traffic between the two sub-networks based on the contents of an access control list stored on the router;

FIG. 3 is a matrix defining an exemplary access control list;

FIG. 4 is an exemplary authentication matrix according to one embodiment of the present invention; and

FIG. 5 is an alternative authentication matrix according to another embodiment of the present invention.

Before any embodiment of the invention is explained in detail, it is to be understood that the invention is not limited in its application to the details of construction and arrangements of components set forth in the following description, or illustrated in the drawings. The invention is capable of alternative embodiments and of being practiced or being carried out in various ways. Also, it is to be understood that the terminology used herein is for the purpose of illustrative description and should not be regarded as limiting.

### DETAILED DESCRIPTION

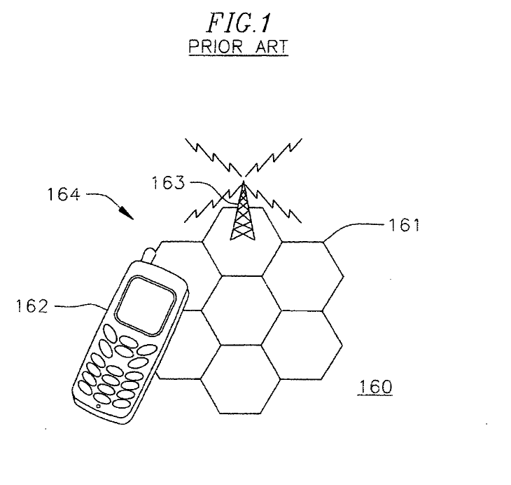

In FIG. 1, a known wireless network 160 is shown to include one or more base stations 163 for communicating with one or more cellular telephones 162. As is known to one skilled in the art, transmission and reception between the base stations 163 and the cellular telephones 162 occurs in a defined coverage area 164 broken into individual geographic cells 161, each having its own base station. The one or more base stations 163 include radio transceivers defining each geographic cell 161 and providing radio-link protocols to the cellular telephones 162. A controller (not shown) may also be coupled between the one or more base stations 163 and a switching center (not shown) to manage and efficiently allocate radio resources for the one or more base stations 163. The controller handles handovers, radio-channel setup and frequency hopping for the cellular telephones 162, for instance as they move from one geographic cell 161 to another.

Communication between the base stations 163 and the cellular telephones 162 may utilize such multi-access wireless communications protocols as general packet radio services, global system for mobile communications and universal mobile telecommunications system protocols, as well as others. In alternative embodiments, High Data Rate (HDR), Wideband Code Division Multiple Access (WCDMA) and/or Enhanced Data Rates for GSM Evolution (EDGE), may also be supported.

With the advancing sophistication of communications technologies, there is an ever-increasing array of services which may be provided on the cellular telephone 162 of FIG. 1. Multiple services may be concurrently provided, such as mail, music, photo and other services in addition to traditional voice service. As such, there are potentially many different types of data which may be stored on the cellular telephones 162 of the wireless network 160. Depending on the sensitivity of this data, there may be a greater or lesser need to secure it against unauthorized access.

To aid in this endeavor, known security measures provide that a user of a cellular telephone must first authenticate herself to that device before she is able to access the features of the device and data stored thereon. For example, to avoid unauthorized users from obtaining access to data stored on the cellular telephone 162, authentication parameters have been used to activate the cellular telephone 162 only when, for instance, the correct authentication code has been entered by the user into a keypad of the cellular telephone 162. The current paradigm is such that once a user has been authenticated to the cellular telephone 162, that user is able to access the full range of features of the cellular telephone 162.

However, the types of data which may be stored on the cellular telephone 162 may vary in importance. Highly important data may require more secure and sophisticated authentication schemes to reduce the risk of unintended disclosure to third parties. There is, however, an inherent tradeoff between the ease with which an authentication method may be practiced and the security of such a method. Entry of a PIN code may be easy to carry out, but offers less security than the authentication of biometric data such as a thumbprint.

As such, it is desirable that a range of methods be available to protect different types of data and different features offered on a cellular telephone. While such a range of authentication parameters is not currently used with cellular telephones, skilled computer scientists will be familiar with the concept of access control lists (“ACLs”) used with computer networks wherein different functional schemes in a network system are made accessible to different users.

ACLs are lists configured at a router to control access to a network, thereby preventing certain traffic from entering or exiting that network, and may be implemented in routers such as firewalls positioned between an internal network and an external network such as the Internet. More specifically, ACLs can be configured for all routed network protocols to filter the packets of those protocols as they pass through the router. By using ACLs to determine which types of traffic are forwarded or blocked at a router interface, the router can be set up, for example, to permit e-mail traffic to be routed while at the same time blocking all Telnet traffic.

To provide the security benefits of ACLs, they should at a minimum be configured on the border routers situated at the edges of a network. This provides a basic buffer from the external network. ACLs are configured for each network protocol configured on the router interfaces. ACLs can also be used on a router positioned between two parts of an internal network to control traffic entering or exiting specific parts of that internal network. Accordingly, less controlled areas of the network may be separated from more sensitive areas of the network, permitting important data to be partitioned in a high security portion of the network architecture.

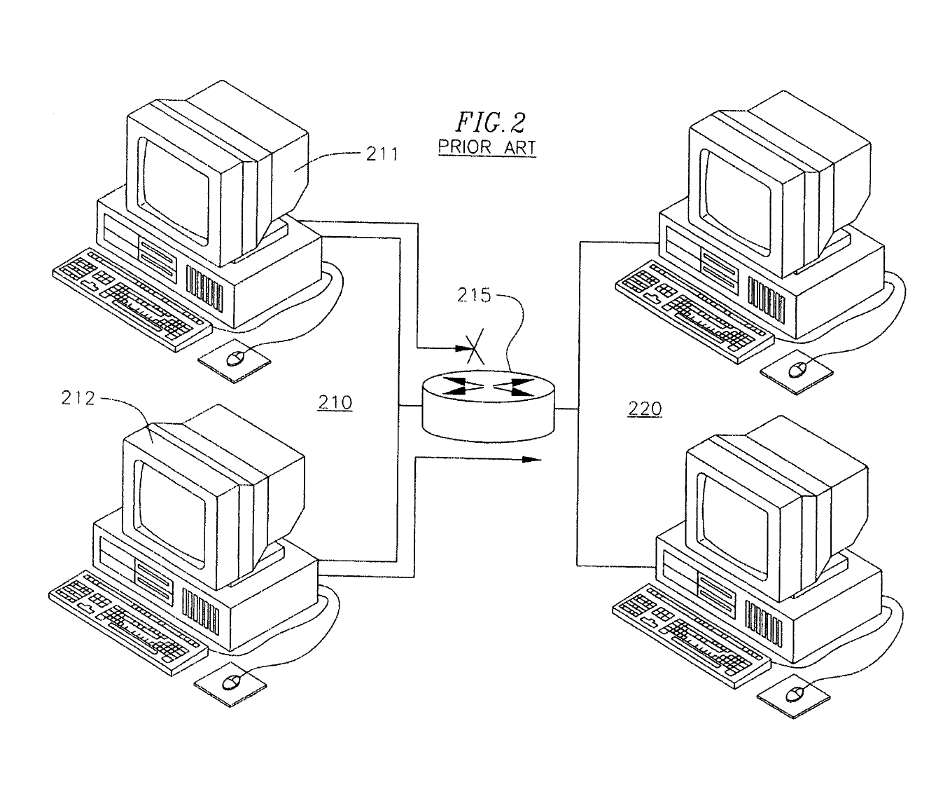

ACLs can be used, for example, to allow one host to access a part of a network and prevent another host from accessing the same area, instead of allowing all packets passing through the router to be allowed onto all parts of the network. FIG. 2 shows a simple architecture in which a first network 210 and a second network 220 are coupled by a router 215. Because of the configuration of an ACL maintained on the router 215, a second host 212 is allowed to access the second network 220 while the first host 211 is prevented from accessing this same network.

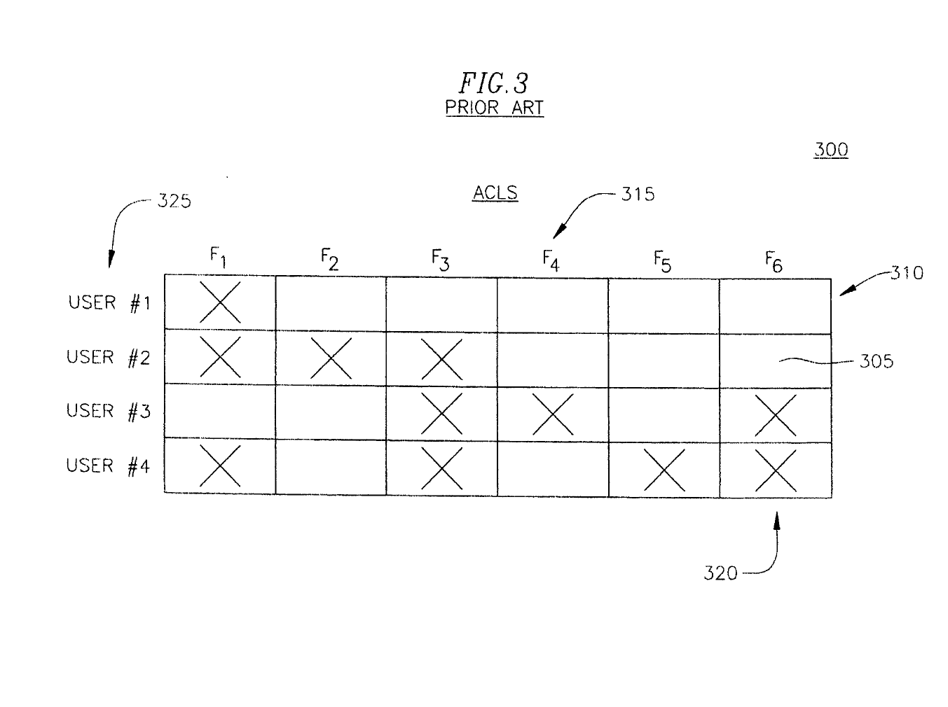

In FIG. 3, a variation of this concept is shown wherein different types of traffic are allowed or denied to different users of a network. An access control list matrix 300 is shown for a series of users 325, wherein user profiles are defined in a series of matrix rows 310. For each user 325, access to one or more applications 315 is determined by that user's corresponding designations in one of a series of matrix columns 320. Multi-dimensional user oriented ACL matrices of the type exemplified by the matrix 300 of FIG. 3 are commonly used between distinct portions of an internal network, such as with the network architecture shown in FIG. 2. In addition, they may also be used to control the distribution of data within individual networks.

Returning now to the problem at hand, a range of methods is provided to protect different types of data and different features offered on a cellular telephone. Whereas the ACLs discussed above provided access to various applications on a network, what is needed is a way of protecting data accessible by various features provided on a cell phone. Furthermore, in lieu of authenticating various users of an ACL to a series of applications, what is needed is a multiplicity of authentication parameters allowing one user to independently enable different features of a cellular telephone.

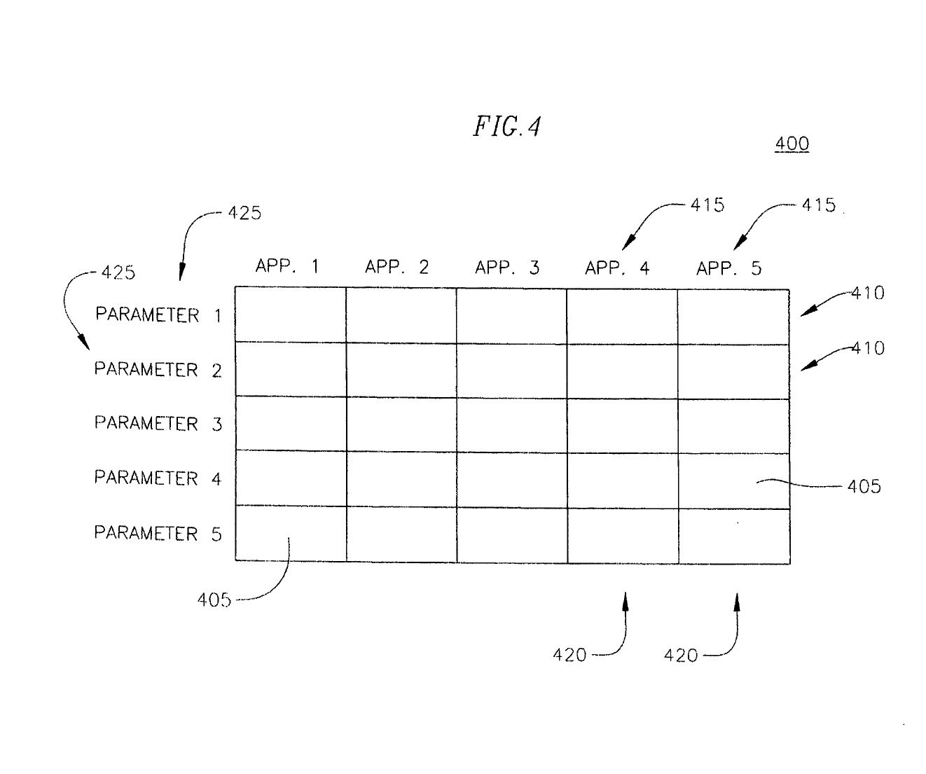

FIG. 4 shows an exemplary authentication matrix 400 according to one embodiment of the present invention having a range of protectable features in another. One or more applications 415 are presented associated with one or more authentication schemes 420 arranged in matrix columns, and one or more authentication parameters (or procedures) 425 are presented associated with one or more matrix rows 410. As such, individual cells 405 are created determining the applicability of a particular authentication parameter 425 to a particular application 415. These authentication parameters 425 can be freely and independently assigned to the applications 415 to create a unique authentication scheme for a cellular telephone.

The range of authentication parameters 425 may include the entry of one or more key codes, biometric data such as a thumbprint, voice analysis, the physical location of the cellular telephone, the time of day, proximity to or use of an enabling device such as a magnetically encoded card, radio frequency identification tag, and the like. This list is not inclusive and it will be apparent to one skilled in the art that any method of authentication, including no authentication method, is appropriate to include in this dimension of the authentication matrix. The range of protectable features is intended to encompass any features that may be offered on the cellular telephone such as telephony services, e-mail, GPS data, stock quotes and the like.

In alternate embodiments of the present invention, one or more than one authentication parameters 425 may be selected for each application 415. In further alternative embodiments, a separate authentication parameter 425 may be used for each application 415, or an authentication parameter 425 may be repeated for more than one application 415.

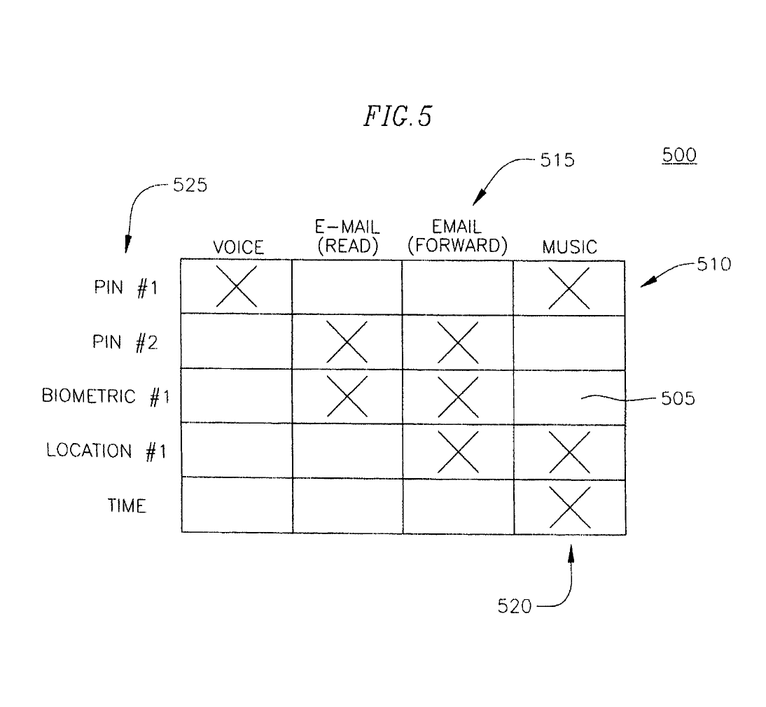

FIG. 5 shows an authentication matrix 500 according to a further embodiment of the present invention wherein specific applications 515 are provided by a cellular telephone. These applications 515 are associated with authentication schemes 520 arranged in matrix columns, and specific authentication parameters 525 for allowing access to the applications 515 on the cellular telephone are associated with matrix rows 510. In the embodiment shown in FIG. 5, the applications 515 include voice telephony services, music services, and e-mail services including the separate applications 515 of access to incoming e-mail, and the ability to alter or forward that e-mail to a third party.

Entries in the individual cells 505 indicate the applicability of a particular authentication parameter 525 to a particular application 515. For example, in the embodiment shown, voice services are provided as an application 515 on a cellular telephone enabled by a user of the cellular telephone authenticating herself by entering a first PIN code. The ability to read stored e-mail is provided as a second application 515 which may be enabled by the a second PIN, together with a biometric authentication procedure. This procedure may include in alternative embodiments, a voice, thumbprint, retina scan or the like. While more cumbersome than the entry of a simple PIN code, this level of security may be necessary if sensitive data is routinely being accessed by the user of the cellular telephone employing the authentication matrix shown in FIG. 5.

In alternative embodiments not shown, rather than being monolithically authenticated, e-mail downloading may be broken into separate higher and lower security applications 515 with distinct authentication schemes based on the source of that e-mail. A directory may be provided having one or more groups of e-mail addresses whereby an authentication scheme is provided for each group of e-mail addresses which may be either higher or lower than the default authentication scheme which allows a user to access e-mail sent from a sender not on the list. In a further alternative embodiment, the ability to download and open attachments to e-mail messages may itself be a separate application 515 requiring its own authentication scheme 520.

The authentication matrix 500 includes the ability to edit and/or forward e-mail received by the cellular telephone as yet another separate application 515, the authentication scheme 520 associated therewith requiring the entry of the second PIN as well as the biometric data. In addition to these two parameters 525, a third parameter is used, namely the physical location of the cellular telephone. This parameter may be provided by known global positioning system (“GPS”) technology incorporated within the cellular telephone such that the authentication parameter 525 is satisfied only when the cellular telephone is in one of a set of predefined geographic locations. For example, a particular application 515 may be restricted so as to only be available when a user is on her corporate campus, at her home, or at another predefined location, providing further increased security to highly sensitive applications 515.

Music downloading and replay applications may be provided as shown in the authentication matrix 500 of FIG. 5 having yet another authentication scheme 520 associated therewith. In addition to the entry of a first PIN, the location of the cellular telephone is again used as an authentication parameter 525. However, a separate list of predefined geographic locations may be provided for this application, as opposed to the application discussed previously. For example, the cellular telephone could be restricted to only allow music services when the user of the device was at a location other than her corporate campus, so that nonessential activities are prevented in a business setting.

In addition, the time of day may be utilized as an authentication parameter 525 so that, for example, the application of accessing music or other entertainment data on a cellular telephone can be restricted to after normal business hours only.

The application of the aforementioned authentication parameters 525 has been discussed in the conjunctive such that for a particular application 515, each designated parameter 525 must be satisfied to authenticate a user so that she may access that particular application 515. However, it is understood that in an alternative embodiment, these authentication parameters 525 may be applied in the disjunctive, so that the entry of any one parameter designated for a particular application enables the usage of that application.

In an alternative embodiment, the authentication parameters 525 may be made to behave in a more subtle fashion using more complex Boolean logic schemes. For example, in the matrix 500 of FIG. 5, an authentication scheme 520 is provided for music or other entertainment services on a cellular telephone. The authentication scheme 520 dictates that a first PIN, as well as a location and a time parameter 525 are all required to authenticate this application 515 for the cellular telephone. For this discussion, these parameters will be referred to as parameters A, D and E. The purely conjunctive authentication scheme produces the Boolean expression (A and D and E)=authentication. However, it is within the purview of the present system and method that, for example, this application always be provided for the user of the cellular telephone when she is at a defined location such as her home. Otherwise, this service may still be available provided the local time is between 5:00 p.m. and 12:00 a.m. and provided the user has entered the correct PIN. This scheme yields the Boolean expression (D or (A and E))=authentication.

Alternately, this application may be provided only between 5:00 p.m. and 12:00 a.m., provided in addition that either the user has entered the correct PIN, or the user of the cellular telephone is at a defined location such as her home. This scheme yields the Boolean expression (E and (A or D))=authentication. This scheme would be useful for both completely preventing the provision of this service during normal business hours, as well as avoiding the hassle of entering a cumbersome PIN assuming the user is at a location that is itself relatively secure.

In a further alternative embodiment, the conditions for satisfying individual parameters can themselves be made to change depending on the satisfaction of other, separate parameters. For instance, the application may be provided only at a defined location such as a user's home if the local time is between 9:00 a.m. and 5:00 p.m., or it may be provided at a different location if the time is otherwise, such as an expanded zone encompassing the user's hometown, provided that the user has also entered the correct PIN. This scheme yields the Boolean expression ((E and D) or (D′ and A))=authentication.

Furthermore, it is also understood that in an alternative embodiment of the present invention, the failure to select any authentication parameters 525 for a particular application 515 is a valid choice. Accordingly, for certain low security applications 515, the authentication scheme 520 may include a null set of authentication parameters. With the advent of increasingly lower cost wireless phone service, a user may for example desire that the simple ability to place telephone calls from her cellular telephone be essentially unprotected, whereas more critical applications such as the ability to access potentially sensitive e-mail information be protected by a password or other authentication parameters 525.

The cellular telephone described for use with the methods above (e.g., the cellular 162 of FIG. 1 when adapted to be used with the methods above) may include a key storage device, which in an exemplary embodiment is provided by a Subscriber Identity Module (“SIM”). SIM cards are widely used in cellular telephones such as cell phones to store a user's personal info, such as contact lists and the like, as well as identifying information. In one embodiment of the present invention, the SIM contains authentication keys specifying particular applications so that the user of the cellular telephone can be identified and authenticated to the cellular telephone to access data using the application specified. The SIM card may include an authentication key having a private key and a related but different public key, a copy of which is made available outside the SIM. It will be apparent to one skilled in the art that while a system using SIM devices has been described herein, the inventive concepts described herein are equally applicable to systems that use other types of smartchips.

In a further alternative embodiment of the present invention, the key storage device of the cellular telephone further includes a Hardware Security Module (“HSM”) chip providing encryption capabilities to add a further level of security to data accessed using the cellular telephone. The HSM chip contains an encryption key for encrypting and decrypting data stored on the cellular telephone. In one embodiment of the present invention, data stored on a SIM, such as retained e-mail traffic, contact information, personal information and the like could be stored in an encrypted state, and decrypted only when needed, using the HSM chip.

Regarding the above described key storage device, a stateless module may be used which provides a high level of security at a relatively low cost, while consuming a relatively small amount of space on the cellular telephone. Mechanisms are provided for securely loading one or more keys into the stateless module, securely storing the keys and securely using the keys. Embodiments of exemplary stateless modules that provide such mechanisms are provided in copending provisional patent application Ser. No. 60/615,290, entitled Stateless Hardware Security Module, filed on Oct. 1, 2004, now filed as patent application Ser. No. 11/159,640, filed Jun. 21, 2005, and Ser. No. 11/159,669, filed Jun. 21, 2005, and assigned to the assignee of the present application, the entire contents of which are incorporated herein by reference.

What is claimed is:

1. A method for authenticating a user to a cellular telephone, the method comprising:
providing a cellular telephone;
providing a matrix having a plurality of authentication parameters in one dimension and a plurality of applications provided by the cellular telephone in another dimension;
associating each of the plurality of applications provided by the cellular telephone with one or more of the plurality of authentication parameters of the matrix; and
satisfying one or more of the associated authentication parameters to provide access to one or more of the associated applications to a user of the cellular telephone.

2. The method of claim 1, wherein each of the plurality of applications is associated with a corresponding one of the plurality of authentication parameters in response to a user selection.

3. The system of claim 1, wherein the satisfying of the one or more of the associated authentication parameters allows the user to access data stored on the cellular telephone using the one or more of the associated applications.

4. The system of claim 3, wherein the data stored on the cellular telephone is stored in an encrypted state.

5. A system comprising:
a cellular telephone for providing a plurality of applications; and
an agent for providing first and second authentication parameters for authenticating a user of the cellular telephone to a first one of the applications and a second one of the applications running on the cellular telephone;
wherein the first one of the applications is enabled by authenticating the user through the first authentication parameter;
wherein the second one of the applications is enabled by authenticating the user through the second authentication parameter;
wherein the agent authenticates the user to the first application following the first authentication parameter; and
wherein the agent authenticates the user to the second application following the second authentication parameter.

6. The system of claim 5, wherein the first application provided by the cellular telephone includes e-mail services.

7. The system of claim 6, wherein the first application provided by the cellular telephone comprises retrieving and displaying of e-mail messages, and wherein the second application provided by the cellular telephone comprises modifying, forwarding and drafting of e-mail messages.

8. The system of claim 6, wherein the first application provided by the cellular telephone comprises downloading and opening attachments to e-mail messages as one application.

9. The system of claim 5, wherein the first authentication parameter comprises an entry of a first pass code, and wherein the second authentication parameter comprises an entry of a second pass code.

10. The system of claim 5, wherein the first authentication parameter comprises a biometric authentication of the user of the cellular telephone.

11. The system of claim 5, wherein the first authentication parameter comprises an authentication of a geographic location of the cellular telephone.

12. The system of claim 5, wherein the first authentication parameter comprises a time based authentication parameter.

13. The system of claim 5, wherein authentication of the user of the cellular telephone by the agent to at least one of the plurality of applications provided by the cellular telephone allows the user to access data stored on the cellular telephone using the at least one of the plurality of the applications.

14. The system of claim 13, wherein the data stored on the cellular telephone is stored in an encrypted state.

15. The system of claim 5, wherein the agent provides third and fourth authentication parameters for authenticating the user of the cellular telephone to a third one of the applications running on the cellular telephone, wherein the third one of the applications is enabled by authenticating the user through the third and fourth authentication parameters, and wherein the agent authenticates the user to the third application following the third and fourth authentication parameters.

16. The system of claim 15, wherein the third authentication parameter comprises an entry of a first pass code, and wherein the fourth authentication parameter comprises an entry of a second pass code.

17. The system of claim 15, wherein the third authentication parameter comprises an authentication of a geographic location of the cellular telephone, and wherein the fourth authentication parameter comprises a time based authentication parameter.

18. A method for authenticating a user to a cellular telephone comprising:
providing one or more applications; and
assigning a plurality of authentication parameters to the one or more applications to authenticate a user of the cellular telephone to the one or more applications;
wherein each authentication parameter has a criterion for satisfaction; and
wherein the criterion for satisfaction of a first one of the authentication parameters changes in response to satisfaction of the criterion of a second one of the authentication parameters.

19. The method of claim 18, further comprising authenticating the user of the cellular telephone to the one or more applications by meeting the criterion for satisfaction of each of the authentication parameters assigned to the one or more applications to allow the user to access data stored on the cellular telephone using the one or more applications.

20. The method of claim 18, wherein the data stored on the cellular telephone is stored in an encrypted state.
